(19) United States
(12) Patent Application Publication
(10) Pub. No.: US 2026/0368636 A1
(43) Pub. Date: Nov. 19, 2026

(54) INFORMATION PROCESSING APPARATUS

(71) Applicant: NEC Corporation, Tokyo (JP)

(72) Inventors: Keita SAKUMA, Tokyo (JP); Ryuta MATSUNO, Tokyo (JP); Masakazu HIROKAWA, Tokyo (JP)

(73) Assignee: NEC Corporation, Tokyo (JP)

(21) Appl. No.: 19/644,034

(22) Filed: Apr. 10, 2026

(30) Foreign Application Priority Data
Apr. 24, 2025 (JP) 2025-072345

(51) Int. Cl. G06N 20/00

(52) U.S. Cl. CPC G06N 20/00

(57) ABSTRACT

An information processing apparatus of the present disclosure includes an acquisition unit that acquires equal to or more than two data sets including data including a pair of an explanatory variable and a target variable, a detection unit that detects change information based on a change in the target variable related to the explanatory variable between the data sets, and a learning unit that performs machine learning in such a way that a relationship between the explanatory variable and the change information is represented by a machine learning model having an interpretable structure.

### INCORPORATION OF BASIC APPLICATION

The present disclosure is based upon and claims the benefit of priority from Japanese patent application No. 2025-072345, filed on Apr. 24, 2025, the disclosure of which is incorporated herein in its entirety by reference.

### TECHNICAL FIELD

The present disclosure relates to an information processing apparatus.

### BACKGROUND ART

Prediction on input data by using a machine learning model has been performed in various fields. On the other hand, in the machine learning model, prediction accuracy may decrease due to a change in data characteristics with a lapse of time (concept drift). For this reason, as described in PTL 1, the concept drift is detected.
PTL 1: WO 2021-079444 A1

### SUMMARY

However, even in a case where the concept drift is detected, it is difficult to appropriately take a measure in the machine learning model against such a concept drift.

Therefore, one of objects of the present disclosure is to solve the above-described problem that it is difficult to appropriately take a measure in a machine learning model against a concept drift.

An information processing apparatus as an aspect of the present disclosure adopts a configuration including
an acquisition unit that acquires equal to or more than two data sets including data including a pair of an explanatory variable and a target variable,
a detection unit that detects change information based on a change in the target variable related to the explanatory variable between the data sets, and
a learning unit that performs machine learning in such a way that a relationship between the explanatory variable and the change information is represented by a machine learning model having an interpretable structure.

An information processing method as an aspect of the present disclosure adopts a configuration including,
by an information processing apparatus,
acquiring equal to or more than two data sets including data including a pair of an explanatory variable and a target variable,
detecting change information based on a change in the target variable related to the explanatory variable between the data sets, and
performing machine learning in such a way that a relationship between the explanatory variable and the change information is represented by a machine learning model having an interpretable structure.

A program as an aspect of the present disclosure adopts a configuration for causing an information processing apparatus to execute processing of
acquiring equal to or more than two data sets including data including a pair of an explanatory variable and a target variable,
detecting change information based on a change in the target variable related to the explanatory variable between the data sets, and
performing machine learning in such a way that a relationship between the explanatory variable and the change information is represented by a machine learning model having an interpretable structure.

An information processing apparatus as an aspect of the present disclosure adopts a configuration including
an acquisition unit that acquires a data set including data including a pair of an explanatory variable and a target variable and having a predetermined attribute, and
a learning unit that divides the data set into a plurality of data set candidates based on the attribute and the explanatory variable, and performs machine learning in such a way that a relationship between the explanatory variable and change information based on a change in the target variable related to the explanatory variable between the data set candidates is represented by a machine learning model having a decision tree structure.

An information processing method as an aspect of the present disclosure adopts a configuration including,
by an information processing apparatus,
acquiring a data set including data including a pair of an explanatory variable and a target variable and having a predetermined attribute, and
dividing the data set into a plurality of data set candidates based on the attribute and the explanatory variable, and performing machine learning in such a way that a relationship between the explanatory variable and change information based on a change in the target variable related to the explanatory variable between the data set candidates is represented by a machine learning model having a decision tree structure.

A program as an aspect of the present disclosure adopts a configuration for causing an information processing apparatus to execute processing of
acquiring a data set including data including a pair of an explanatory variable and a target variable and having a predetermined attribute, and
dividing the data set into a plurality of data set candidates based on the attribute and the explanatory variable, and performing machine learning in such a way that a relationship between the explanatory variable and change information based on a change in the target variable related to the explanatory variable between the data set candidates is represented by a machine learning model having a decision tree structure.

With the above configuration, the present disclosure can appropriately take a measure in a machine learning model against a concept drift.

### BRIEF DESCRIPTION OF THE DRAWINGS

FIG. 1 is a block diagram illustrating an example of a configuration of an information processing apparatus in the present disclosure;

FIG. 2 is a block diagram illustrating an example of the configuration of the information processing apparatus in the present disclosure;

FIG. 3 is a flowchart illustrating an example of a processing operation by the information processing apparatus in the present disclosure;

FIG. 4 is a diagram illustrating an example of processing by the information processing apparatus in the present disclosure;

FIG. 5 is a diagram illustrating an example of the processing by the information processing apparatus in the present disclosure;

FIG. 6 is a diagram illustrating an example of the processing by the information processing apparatus in the present disclosure;

FIG. 7 is a diagram illustrating an example of the processing by the information processing apparatus in the present disclosure;

FIG. 8 is a diagram illustrating an example of the processing by the information processing apparatus in the present disclosure;

FIG. 9 is a flowchart illustrating an example of a processing operation by an information processing apparatus in the present disclosure;

FIG. 10 is a diagram illustrating an example of processing by the information processing apparatus in the present disclosure;

FIG. 11 is a diagram illustrating an example of the processing by the information processing apparatus in the present disclosure;

FIG. 12 is a block diagram illustrating an example of a hardware configuration of an information processing apparatus in the present disclosure;

FIG. 13 is a block diagram illustrating an example of a configuration of the information processing apparatus in the present disclosure;

FIG. 14 is a flowchart illustrating an example of a processing operation by the information processing apparatus in the present disclosure;

FIG. 15 is a block diagram illustrating an example of the configuration of the information processing apparatus in the present disclosure; and

FIG. 16 is a flowchart illustrating an example of the processing operation by the information processing apparatus in the present disclosure.

### EXAMPLE EMBODIMENT

### First Example Embodiment

A first example embodiment of the present disclosure will be described with reference to the drawings. The drawings may relate to any example embodiment.

In the present disclosure, content of a concept drift in which a probability distribution p(y|x) of a target variable y with respect to an explanatory variable x changes in a prediction model h that has learned, by machine learning, a relationship between the explanatory variable x and the target variable y is to be analyzed. In particular, in the present example embodiment, it is assumed that when and where the concept drift in the prediction model h has occurred and how the concept has changed are analyzed, and an analysis result is output in a format interpretable by a human. By analyzing the change in p(y|x) in this manner, it is possible to appropriately cope with performance deterioration of the prediction model h.

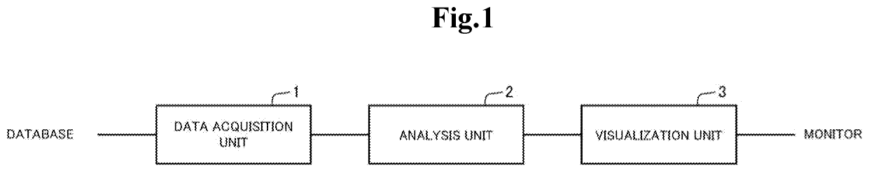

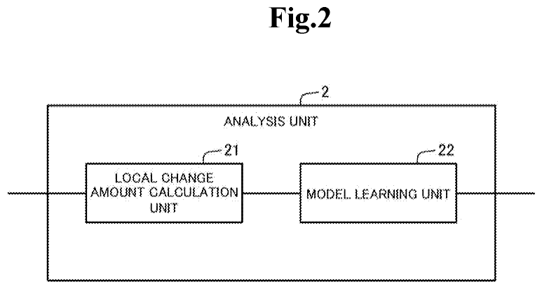

Hereinafter, an example of a configuration and an operation of an information processing apparatus in the present example embodiment will be described. The information processing apparatus is constituted by a single or a plurality of information processing apparatuses including an arithmetic device and a storage device. As illustrated in FIG. 1, the information processing apparatus includes a data acquisition unit 1, an analysis unit 2, and a visualization unit 3. As illustrated in FIG. 2, the analysis unit 2 includes a local change amount calculation unit 21 and a model learning unit 22. Each function of the data acquisition unit 1, the analysis unit 2, the visualization unit 3, the local change amount calculation unit 21, and the model learning unit 22 can be achieved by the arithmetic device executing a program for achieving each function stored in the storage device.

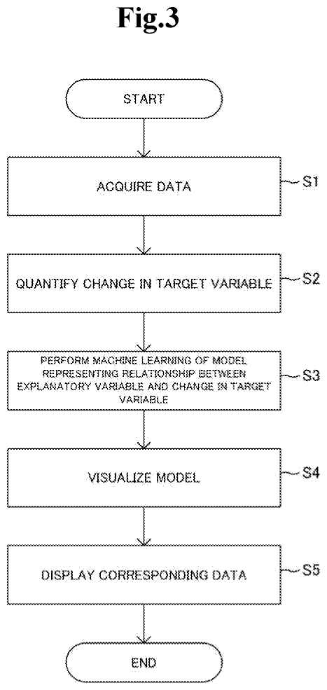

The data acquisition unit 1 (acquisition unit) acquires, as data to be processed, sample data including a pair that can be the explanatory variable x and the target variable y in the prediction model h described above (step S1 in FIG. 3). Specifically, the data acquisition unit 1 acquires equal to or more than two data sets D having different attributes, each of which includes a set of sample data stored in advance in a database. In the present example embodiment, the attribute of the data sets D is a time, and as indicated in Expression 1, a data set 1: D⁽¹⁾ and a data set 2: D⁽²⁾, which are two data sets having different times, are acquired. For example, the data set 1 includes sample data at the time before that of the data set 2 in time series. As an example, the data set 1 is learning data used at the time of machine learning of the prediction model h, and the data set 2 is operation data used at the time of operation of the prediction model h subjected to the machine learning. Sets X⁽¹⁾ and X⁽²⁾ of explanatory variables of each sample data are indicated in Expression 2. At this time, the data acquisition unit 1 may acquire time stamps T⁽¹⁾ and T⁽²⁾ representing the times related to the sample data, as indicated in Expression 3.

$$[ Expression 1 ]$$

$${D}^{( 1 )} := {\{ ( {x}_{i}^{( 1 )} , {y}_{i}^{( 1 )} ) \}}_{i = 1}^{{N}^{( 1 )}}$$

$${D}^{( 2 )} := {\{ ( {x}_{i}^{( 2 )} , {y}_{i}^{( 2 )} ) \}}_{i = 1}^{{N}^{( 2 )}}$$

$$[ Expression 2 ]$$

$${X}^{( 1 )} := \{ {x}_{i} \vert ( {x}_{i} , {y}_{i} ) ∈ {D}^{( 1 )} \}$$

$${X}^{( 2 )} := \{ {x}_{i} \vert ( {x}_{i} , {y}_{i} ) ∈ {D}^{( 2 )} \}$$

$$[ Expression 3 ]$$

$${T}^{( 1 )} := {\{ {t}_{i}^{( 1 )} \}}_{i = 1}^{{N}^{( 1 )}}$$

$${T}^{( 2 )} := {\{ {t}_{i}^{( 2 )} \}}_{i = 1}^{{N}^{( 2 )}}$$

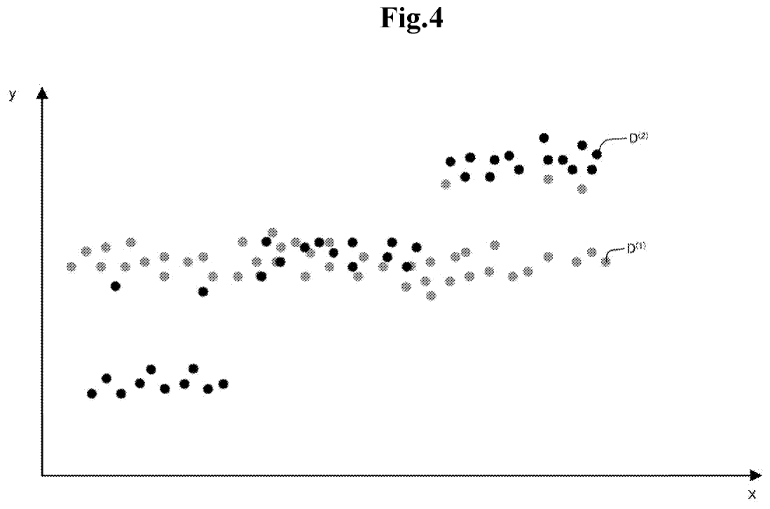

Here, FIG. 4 illustrates an example in which the data set 1: D⁽¹⁾ and the data set 2: D⁽²⁾ are plotted in a coordinate space of the explanatory variable x and the target variable y. In this drawing, gray plots are the sample data of the data set 1: D⁽¹⁾, and black plots are the sample data of the data set 2: D⁽²⁾.

In the present example embodiment, a case where the time is different as the attribute between the data set 1 and the data set 2 will be described as an example, but the attribute different between the data set 1 and the data set 2 is not limited to the time. For example, the attribute different between the data set 1 and the data set 2 may be any attribute such as a place (region) where the sample data is acquired or an object from which the sample data is to be acquired.

The analysis unit 2 compares the data set 1 with the data set 2 by the local change amount calculation unit 21 (detection unit), and detects change information based on a change in the target variable y related to the explanatory variable x between the data sets 1 and 2. In the present example embodiment, for example, the local change amount calculation unit 21 quantifies a change amount s of the local target variable y in the explanatory variable x for each sample data of the data set 1 or the data set 2 (step S2 in FIG. 3). Specifically, as an example, the local change amount calculation unit 21 calculates a set S of change amounts of p(y|x) at points in X for a set X of the explanatory variables x by any one of the following two methods.

As a first method, the local change amount calculation unit 21 calculates the set S of the change amounts by a method based on a k-nearest neighbor sample as follows.

First, for each sample data xᵢ⁽²⁾ (i=1, 2, . . . , N⁽²⁾) of the data set 2, the local change amount calculation unit 21 defines a neighboring region of xᵢ⁽²⁾ as a hypersphere having a radius rᵢ⁽²⁾ centered on xᵢ⁽²⁾ as indicated in Expression 4.

$$[ Expression 4 ]$$

$${r}_{i}^{( 2 )} := {‖ {x}_{i}^{( 2 ) , k} - {x}_{i}^{( 2 )} ‖}_{2}$$

Here, it is assumed that xᵢ^{(2),k} is sample data in the data set 2 that is the k-th nearest to xᵢ⁽²⁾.

Subsequently, the local change amount calculation unit 21 extracts the target variables y of the sample data in neighboring regions of the data set 1 and the data set 2 as indicated in Expression 5.

$$[ Expression 5 ]$$

$${Y}_{i}^{( 1 ) , nn} = \{ {y}_{j}^{( 1 )} \vert {‖ {x}_{j}^{( 1 )} - {x}_{i}^{( 2 )} ‖}_{2} \leq {r}_{i}^{( 2 )} , j ∈ \{ 1 , … , {N}^{( 1 )} \} \}$$

$${Y}_{i}^{( 2 ) , nn} = \{ {y}_{j}^{( 2 )} \vert {‖ {x}_{j}^{( 2 )} - {x}_{i}^{( 2 )} ‖}_{2} \leq {r}_{i}^{( 2 )} , j ∈ \{ 1 , … , {N}^{( 2 )} \} \}$$

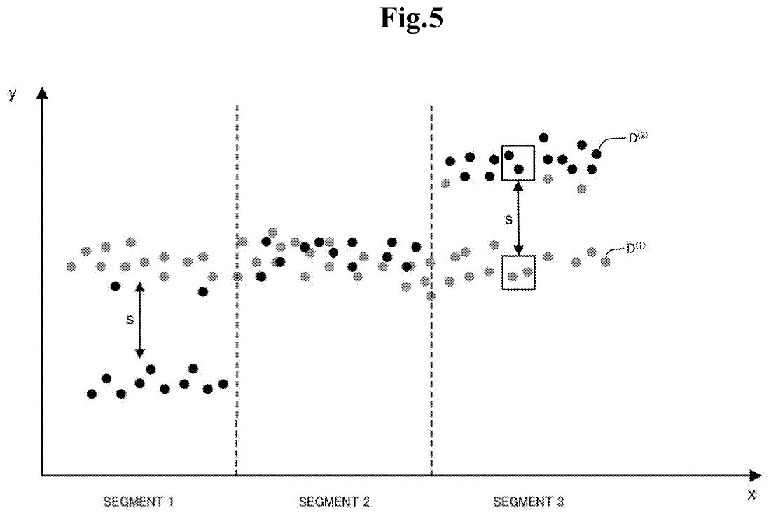

Subsequently, as illustrated in FIG. 5, the local change amount calculation unit 21 calculates a local distribution change amount sᵢ of p(y|x) in xᵢ⁽²⁾ from the extracted target variables y in the data set 1 and the data set 2. It is assumed that a definition of s can be any index as long as it can quantify a difference in distribution in a certain form.

Specifically, in a case where the prediction model h is a regression model, the local change amount calculation unit 21 may calculate the local distribution change amount sᵢ by defining the local distribution change amount sᵢ by a difference between averages as indicated in the following Expression 6.

$$[ Expression 6 ]$$

$${s}_{i} = \frac{{\sum }_{γ ∈ {Y}_{i}^{( 2 ) , nn}} y}{\vert {Y}_{i}^{( 2 ) , nn} \vert} - \frac{{\sum }_{γ ∈ {Y}_{i}^{( 1 ) , nn}} y}{\vert {Y}_{i}^{( 1 ) , nn} \vert}$$

However, the local distribution change amount sᵢ may be calculated by utilizing a statistic change amount (an average rate of change, a difference or rate of change in variance, or the like), a distance between distributions (a KL distance, a Wasserstein distance, or the like), and a statistical test (a p value of a two-sample test, or the like).

In a case where the prediction model h is a classification model, the local change amount calculation unit 21 may calculate probability distributions of classes indicated in Expression 7 from class ratios in Yᵢ^{(1),nm} and Yᵢ^{(2),nm}, and then quantify a difference in the probability distribution. For example, a total variation distance may be used for the calculation.

$$[ Expression 7 ]$$

$${p}_{i}^{( 1 ) , nn} = ( {p}_{i , 1}^{( 1 )} , {p}_{i , 2}^{( 1 )} , … , {p}_{i , K}^{( 1 )} )$$

$${p}_{i}^{( 2 ) , nn} = ( {p}_{i ,}^{( 2 )} , {p}_{i , 2}^{( 2 )} , … , {p}_{i , K}^{( 2 )} )$$

As described above, the set S of the local distribution change amounts in the set of explanatory variables indicated in Expression 8 can be calculated by Expression 9.

$$[ Expression 8 ]$$

$$X := {X}^{( 2 )}$$

$$[ Expression 9 ]$$

$$S := {\{ {s}_{i} \}}_{i = 1}^{{N}^{( 2 )}}$$

In the above description, in a case where the number of target variables extracted is small, the calculation of sᵢ for i may be skipped. In the above example, the distribution change amount is calculated for each sample data of the data set 2, but the calculation may be performed for each point of the data set 1, or may be performed for both.

As a second method, the local change amount calculation unit 21 calculates the set S of the change amounts by a method based on a model as follows.

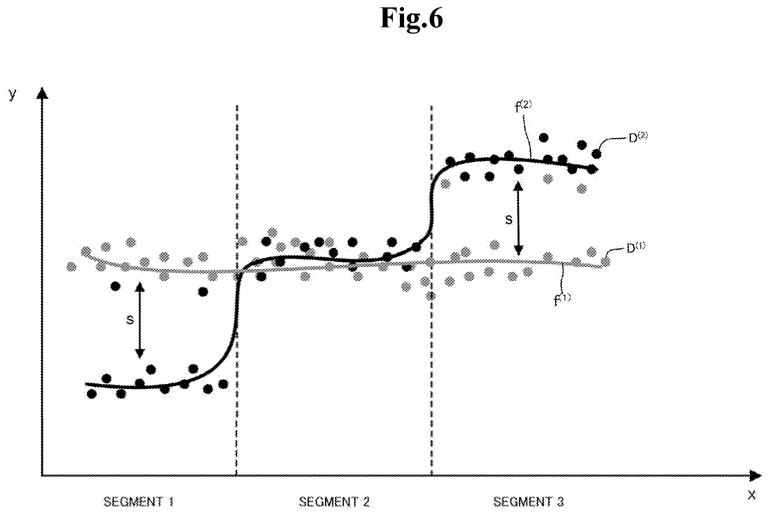

First, as illustrated in curves in FIG. 6, the local change amount calculation unit 21 learns a relationship between the explanatory variable x and the target variable y of the data set 1 by using a machine learning model, and sets the relationship as f⁽¹⁾, and learns a relationship between the explanatory variable x and the target variable y of the data set 2 by using the machine learning model, and sets the relationship as f⁽²⁾. At this time, the local change amount calculation unit 21 may use a point estimation model or a conditional distribution estimation model as the model that learns each of the data sets 1 and 2 by machine learning. For example, in the case of the point estimation model, a decision tree, gradient boosted decision trees (GBDT), a random forest, or a neural network may be used, and in the case of the distribution estimation model, a Gaussian process regression, a Bayesian neural network, or a probabilistic classification model may be used. The model that learns each of the data sets 1 and 2 by the machine learning may be other than the models exemplified above, and an optional model can also be utilized.

The local change amount calculation unit 21 then combines the data set 1 and the data set 2 into Expression 10, and calculates the local distribution change amount sᵢ in Expression 11. For example, as indicated in Expression 12 and FIG. 6, the local distribution change amount sᵢ is calculated by being defined by a difference between expected values. Various indices such as the distance between distributions exemplified above can be calculated by using the conditional distribution estimation model.

X:=x⁽¹⁾∪X⁽²⁾ [Expression 10]

xᵢ∈X [Expression 11]

sᵢ:=f⁽²⁾(xᵢ)−f⁽¹⁾(xᵢ) [Expression 12]

As described above, the set S of the change amounts with respect to X can be calculated as in Expression 13.

S:={sᵢ|xᵢ∈X} [Expression 13]

In the present disclosure, the method is not limited to the above-described methods, and any other method may be used as long as it can calculate the set S of the change amounts s of p(y|x) in the points in X.

The present disclosure is not necessarily limited to quantifying the change amount s of p(y|x), and any value may be quantified as long as the value is based on the change in p(y|x). For example, the local change amount calculation unit 21 may quantify a pattern s including a direction of a temporal change that is an attribute of each sample data. At this time, it is assumed that the pattern s is a certain amount that can be defined using the target variable y and information regarding a time stamp (time) t. As an example of the pattern s, as information representing a change in the target variable y with respect to a change in the time, a speed of the change in the target variable y may be quantified as a change s, as indicated in the following Expression 14.

$$[ Expression 14 ]$$

$$knn - based {s}_{i} = \frac{\{ \frac{{\sum }_{γ ∈ {Y}_{i}^{( 2 ) , nn}} y}{\vert {Y}_{i}^{( 2 ) , nn} \vert} - \frac{{\sum }_{γ ∈ {Y}_{i}^{( 1 ) , nn}} y}{\vert {Y}_{i}^{( 1 ) , nn} \vert} \}}{{t}_{2} - {t}_{1}} = \frac{\begin{matrix}any change amount between new and \\ old ( this can be calculated by various indices )\end{matrix}}{time taken} model - based {s}_{i} := \frac{{f}^{( 2 )} ( {x}_{i} ) - {f}^{( 1 )} ( {x}_{i} )}{{t}_{2} - {t}_{1}}$$

It is assumed that the above t1 and t2 are times (average times) when the data set 1 and the data set 2 are collected.

The analysis unit 2 then causes the model learning unit 22 (learning unit) to perform machine learning in such a way that a relationship between the set X of the explanatory variables and the set S of the change amounts s quantified as described above is represented by the machine learning model (step S3 in FIG. 3). Specifically, the model learning unit 22 uses X as the explanatory variable and S as the target variable, and performs machine learning of a model g having an interpretable structure representing the relationship between X and S. At this time, as the model g having the interpretable structure, a model having a decision tree structure or a model having a rule-based structure is preferable.

As a device for improving interpretability when the model g is subjected to the machine learning, it is assumed that the model learning unit 22 may set a parameter in such a way that a depth of a tree does not become too deep in the case of the learning with a decision tree, and prevent a length of an if-then rule from becoming too long and use only a part of variables among the explanatory variables included in X for the learning in the case of a rule-based model. For example, it is also assumed that, in a case where there are variables having a high correlation, only one of the variables may be used, and as an example, in a case where there are an average temperature, a highest temperature, and a lowest temperature, only the average temperature may be used. For example, it is also assumed that only variables having high interpretability may be narrowed down, and as an example, in a case where there are the average temperature, a square of the average temperature, and a square root of the average temperature, only the average temperature may be used.

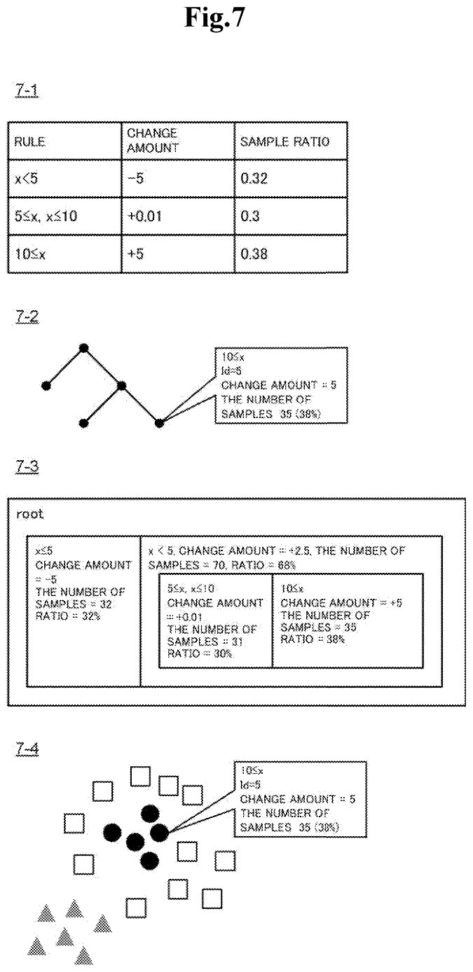

The visualization unit 3 (output unit) visualizes at least a part of the model g subjected to the machine learning as described above (step S4 in FIG. 3). For example, the visualization unit 3 outputs rules of the model g, corresponding sample data, and the like as described below to be displayed on a monitor browsable by a user. Here, it is assumed that the model g having the decision tree structure is subjected to the machine learning as the interpretable model by the model learning unit 22 described above. In this case, for example, as illustrated in FIG. 7(7-1), the visualization unit 3 displays a rule table indicating a list of branch rules corresponding to nodes in the decision tree, and outputs, together with each rule, information based on the rule such as a prediction value, that is, the change amount s by the model g in the related rule, the number and a ratio of sample data satisfying the related rule, and the like to be displayed.

For example, as illustrated in FIG. 7(7-2), the visualization unit 3 may display a tree diagram of the decision tree including the nodes and edges, and display the branch rule corresponding to each node, the prediction value in the related branch rule, the number and ratio of sample data satisfying the related branch rule, and the like. At this time, in a case where a predetermined node is selected by the user in the tree diagram, information related to the branch rule corresponding to such a node may be displayed. At this time, a color of the node to be displayed may be displayed in a color related to the corresponding prediction value.

For example, as illustrated in FIG. 7(7-3), the visualization unit 3 may visualize and output the model g with Treemap that is a format in which hierarchical data is expressed in rectangular regions. For example, the visualization unit 3 may display the branch rule in each segment (region) in Treemap, and display the corresponding branch rule, the prediction value, the number and ratio of sample data, and the like in each segment. At this time, a size of the segment may be adjusted and displayed according to the number and ratio of sample data satisfying the corresponding branch rule, and/or a color of the segment may be displayed in a color related to the corresponding prediction value.

For example, the visualization unit 3 may reduce a dimension of each sample data of the data set 1 and the data set 2 (for example, to two or three dimensions), and output a scatter diagram of the dimensionally reduced sample data to be displayed as illustrated in FIG. 7(7-4). In the example of FIG. 7(7-4), the dimension of the sample data is reduced to two dimensions, and each sample data is displayed by each marker such as a circle, a square, or a triangle. At this time, a shape of the marker is distinguished for each branch rule (segment), and a color of the marker is set according to the change amount. In a case where a predetermined marker is selected by the user, the visualization unit 3 may display information related to the branch rule corresponding to such a marker. In a case where the predetermined sample data is selected by the user, the visualization unit 3 may further display markers related to sample data of the same segment as the selected sample data by connecting or enclosing the markers with a line. Various dimension reduction methods such as an autoencoder (AE), a variational autoencoder (VAE), multi-dimensional scaling (MDS), T-distributed stochastic neighbor embedding (TSNE), and uniform manifold approximation and projection (UMAP) can be used to reduce the dimension of the sample data.

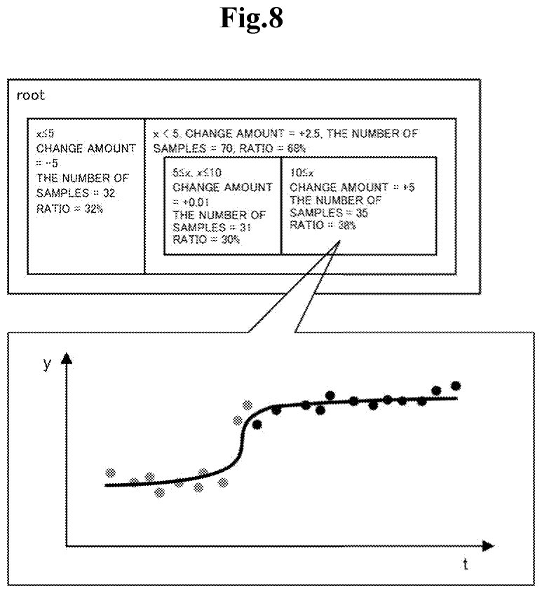

The visualization unit 3 further plots and displays information related to the target variable corresponding to the rule displayed as described above on a predetermined coordinate space (step S5 in FIG. 3). For example, as illustrated in FIG. 8, in a case where a predetermined segment is selected by the user in Treemap, the visualization unit 3 outputs the target variable y of sample data corresponding to a rule of the selected segment to be plotted and displayed on a coordinate space of the time and the target variable. In this manner, by plotting the target variable y satisfying the predetermined rule in time series, a trend of the change can be visualized. At this time, the plot may be displayed together with a smoothed curve such as a moving average of the target variable y. Also in a case where a predetermined node portion is selected in the tree diagram described above or in a case where a predetermined rule portion is selected in the rule table described above, the visualization unit 3 may display a time-series change of the target variable y corresponding to the rule of the selected node as illustrated in FIG. 8.

Here, a specific application example of the above-described information processing apparatus will be described. Here, it is assumed that a patient number prediction model is operated on the assumption of a case where the number of patients is predicted in a predetermined hospital. It is assumed that, in the hospital, a prediction value of the patient number prediction model is utilized for optimization of the number of reservation frames, optimization of drug inventory, and the like by linking the prediction value with a reservation management system or the like.

In this case, it is assumed that the explanatory variable x in the patient number prediction model is a weather, a temperature, a day of the week, a disease name, a latest bed use rate, and a holiday/weekday label, and for example, the latest bed use rate and the disease name are acquired from the reservation management system or the like, the weather is acquired from the Japan Meteorological Agency API, and the temperature is acquired from a sensor or the like. It is also assumed that the target variable y is the number of patients after one week.

In the above-described situation, it is assumed that performance of the patient number prediction model in operation is significantly deteriorated. It is assumed that, in the hospital, detailed knowledge related to a change in data distribution is needed in order to examine a policy of relearning of the patient number prediction model, and analysis is performed using the information processing apparatus of the present disclosure described above.

Specifically, the information processing apparatus first acquires training data of the patient number prediction model as the data set 1 described above, and acquires operation data of the patient number prediction model as the data set 2. The information processing apparatus then analyzes these data sets 1 and 2, performs machine learning in such a way that a change in the target variable is represented by an interpretable model as described above, and visualizes and outputs a rule by the model. As a result, for example, it can be seen that “the bed use rate on weekdays of the disease name: ∘∘ significantly increases”, and it can be seen that “the disease name: ∘∘ becomes widespread” and “the patients come to the hospital regardless of holidays and weekdays”. In particular, it can also be seen that “the disease name ∘∘ increased rapidly from around March 2020”. From these, the hospital can take a measure that “only the weekday samples of the disease name ∘∘ are relearned by limiting to data after March 2020”. Then, it is possible to support decision making by a doctor by improving prediction accuracy of the patient number prediction model.

As described above, in the present disclosure, the rule in the model can be easily interpreted by performing the machine learning in such a way that the relationship between the explanatory variable and the change in the target variable of the data set is represented by the interpretable model. As a result, it is possible to easily interpret when and where the change in the target variable, that is, the concept drift has occurred and how the concept has changed, and to appropriately cope with the performance deterioration of the prediction model.

### Second Example Embodiment

Next, a second example embodiment of the present disclosure will be described with reference to the drawings. The drawings may relate to any example embodiment.

An information processing apparatus in the present example embodiment has a configuration similar to that of the first example embodiment described above. In addition, the information processing apparatus has the following configuration. Hereinafter, the configuration different from the above will be mainly described. It is assumed that a data acquisition unit 1 and an analysis unit 2 in the present example embodiment perform processing by three different methods as described below.

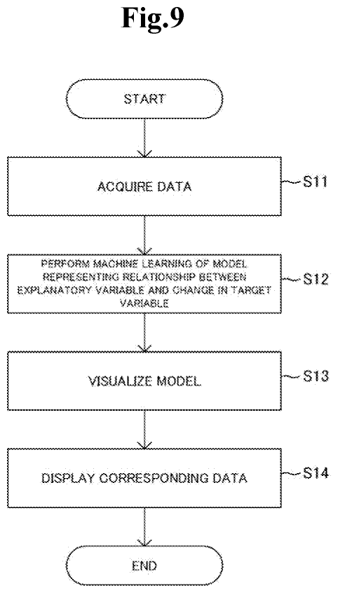

First, processing by a first method by the data acquisition unit 1 and the analysis unit 2 of the information processing apparatus in the present example embodiment will be described. In the first method, the data acquisition unit 1 (acquisition unit) acquires, as data to be processed, sample data including a pair that can be an explanatory variable x and a target variable y in a prediction model h as described above (step S11 in FIG. 9). Specifically, the data acquisition unit 1 acquires equal to or more than two data sets D having different attributes, each of which includes a set of sample data stored in advance in a database. In the present example embodiment, the attribute of the data sets D is a time, and as indicated in Expression 15, a data set 1: D⁽¹⁾ and a data set 2: D⁽²⁾, which are two data sets having different times, are acquired. For example, the data set 1 includes sample data at the time before that of the data set 2 in time series. As an example, the data set 1 is learning data used at the time of machine learning of the prediction model h, and the data set 2 is operation data used at the time of operation of the prediction model h subjected to the machine learning. Sets X⁽¹⁾ and X⁽²⁾ of explanatory variables of each sample data are indicated in Expression 16. At this time, the data acquisition unit 1 may acquire time stamps T⁽¹⁾ and T⁽²⁾ representing the times related to the sample data, as indicated in Expression 17.

$$[ Expression 15 ]$$

$${D}^{( 1 )} := {\{ ( {x}_{i}^{( 1 )} , {y}_{i}^{( 1 )} ) \}}_{i = 1}^{{N}^{( 1 )}}$$

$${D}^{( 2 )} := {\{ ( {x}_{i}^{( 2 )} , {y}_{i}^{( 2 )} ) \}}_{i = 1}^{{N}^{( 2 )}}$$

$$[ Expression 16 ]$$

$${X}^{( 1 )} := \{ {x}_{i} \vert ( {x}_{i} , {y}_{i} ) ∈ {D}^{( 1 )} \}$$

$${X}^{( 2 )} := \{ {x}_{i} \vert ( {x}_{i} , {y}_{i} ) ∈ {D}^{( 2 )} \}$$

$$[ Expression 17 ]$$

$${T}^{( 1 )} := {\{ {t}_{i}^{( 1 )} \}}_{i = 1}^{{N}^{( 1 )}}$$

$${T}^{( 2 )} := {\{ {t}_{i}^{( 2 )} \}}_{i = 1}^{{N}^{( 2 )}}$$

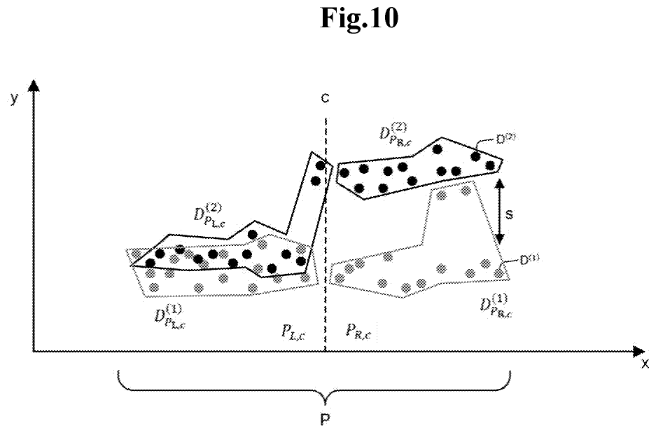

Here, FIG. 10 illustrates an example of a part of the data set 1: D⁽¹⁾ and data set 2: D⁽²⁾ plotted in a coordinate space of the explanatory variable x and the target variable y. In this drawing, gray plots are the sample data of the data set 1: D⁽¹⁾, and black plots are the sample data of the data set 2: D⁽²⁾. All samples of the data sets 1 and 2 are, for example, similar to those in FIG. 4.

In the present example embodiment, a case where the time is different as the attribute between the data set 1 and the data set 2 will be described as an example, but the attribute different between the data set 1 and the data set 2 is not limited to the time. For example, the attribute different between the data set 1 and the data set 2 may be any attribute such as a place (region) where the sample data is acquired or an object from which the sample data is to be acquired.

The analysis unit 2 (learning unit) of the information processing apparatus in the present example embodiment then performs machine learning in such a way that a relationship between the explanatory variable x and a change in the target variable y is represented by a machine learning model having a decision tree structure based on the data sets 1 and 2 described above (step S12 in FIG. 9). Specifically, it is assumed that the analysis unit 2 performs machine learning for learning a rule for further dividing, by the explanatory variable x, the data sets 1 and 2 divided by the time as follows.

The analysis unit 2 arranges all the sample data of the data sets 1 and 2 in a root node as an initial state. The analysis unit 2 then recursively repeats the following processing starting from the root node. It is assumed that a root node P=X is the entire input space (feature space).

The analysis unit 2 sets a divided region (partition) of a parent node (current node) as in Expression 18, and extracts a data set 1: D_{P}⁽¹⁾ and a data set 2: D_{P}⁽²⁾ belonging to P as indicated in Expression 19.

$$[ Expression 18 ]$$

$$P ⊂ χ$$

$$[ Expression 19 ]$$

$${D}_{P}^{( 1 )} := \{ ( {x}_{i} , {y}_{i} ) ∈ {D}^{( 1 )} \vert {x}_{i} ∈ P \}$$

$${D}_{P}^{( 2 )} := \{ ( {x}_{i} , {y}_{i} ) ∈ {D}^{( 2 )} \vert {x}_{i} ∈ P \}$$

Subsequently, the analysis unit 2 generates a division candidate set C (data set candidate). For example, a method similar to that of a normal decision tree can be used to create the division candidate set. Specifically, as indicated in Expression 20, the analysis unit 2 searches for possible division candidates c (for example, threshold candidates for a numerical attribute and grouping of categories for a category attribute) of a division point for each explanatory variable x based on samples in the data sets 1 and 2, and sets the division candidates c as the division candidate set C. At this time, the division candidate c indicated in Expression 21 is, for example, a combination of a type of the explanatory variable and a threshold. When it is assumed that divided regions of left and right child nodes divided by the division candidate c are P_{L,c} and P_{R,c}, four sample sets belonging to the child nodes divided by the time as the attribute and the explanatory variable can be defined as indicated in Expression 22 and FIG. 10.

$$[ Expression 20 ]$$

$${D}_{P}^{( 1 )} ⋃ {D}_{P}^{( 2 )}$$

$$[ Expression 21 ]$$

$$c ∈ C$$

$$[ Expression 22 ]$$

$${D}_{{P}_{L , c}}^{( 1 )} := \{ ( {x}_{i} , {y}_{i} ) ∈ {D}^{( 1 )} \vert {x}_{i} ∈ {P}_{L , c} \}$$

$${D}_{{P}_{R , c}}^{( 1 )} := \{ ( {x}_{i} , {y}_{i} ) ∈ {D}^{( 1 )} \vert {x}_{i} ∈ {P}_{R , c} \}$$

$${D}_{{P}_{L , c}}^{( 2 )} := \{ ( {x}_{i} , {y}_{i} ) ∈ {D}^{( 2 )} \vert {x}_{i} ∈ {P}_{L , c} \}$$

$${D}_{{P}_{R , c}}^{( 2 )} := \{ ( {x}_{i} , {y}_{i} ) ∈ {D}^{( 2 )} \vert {x}_{i} ∈ {P}_{R , c} \}$$

When the division candidate set C is constructed, restriction may be applied in such a way that the number of samples indicated in Expression 23 is not excessively biased.

$$[ Expression 23 ]$$

$$( \vert {D}_{{P}_{L , c}}^{( 1 )} \vert , \vert {D}_{{P}_{R , c}}^{( 1 )} \vert , \vert {D}_{{P}_{L , c}}^{( 2 )} \vert , \vert {D}_{{P}_{R , c}}^{( 2 )} \vert )$$

Subsequently, the analysis unit 2 calculates a division evaluation index in each division candidate. At this time, the division evaluation index may have any value as long as a difference between distribution change amounts of the target variables of the left and right child nodes can be evaluated. As an example, the division evaluation index is set as in Expression 24.

$$[ Expression 24 ]$$

$${s}_{diff , c} := \vert s ( {Y}_{{P}_{L , c}}^{( 1 )} , {Y}_{{P}_{L , c}}^{( 1 )} ) - s ( {Y}_{{P}_{R , c}}^{( 1 )} , {Y}_{{P}_{R , c}}^{( 2 )} ) \vert ( {Y}_{{P}_{L , c}}^{( 1 )} is a target variable portion of {D}_{{P}_{L , c}}^{( 1 )} )$$

Here, the above s may be any index as long as the index quantifies the distribution change amount of the target variable. For example, the above s may be a statistic change amount (a difference in average or a difference in variance), a distance between distributions (KL or Wasserstein), or a p value of a statistical test.

The division evaluation index may be set as in Expression 25, and a device for reducing the division evaluation index when the number of samples is biased may be employed. The division evaluation index may be set as in Expression 26, and a difference in distribution between left and right may be considered.

$$[ Expression 25 ]$$

$${s}_{diff , c} := \vert s ( {Y}_{{P}_{L , c}}^{( 1 )} , {Y}_{{P}_{L , c}}^{( 1 )} ) - s ( {Y}_{{P}_{R , c}}^{( 1 )} , {Y}_{{P}_{R , c}}^{( 2 )} ) \vert \times min \{ \vert {D}_{{P}_{L , c}}^{( 1 )} \vert , \vert {D}_{{P}_{R , c}}^{( 1 )} \vert , \vert {D}_{{P}_{L , c}}^{( 2 )} \vert , \vert {D}_{{P}_{R , c}}^{( 2 )} \vert \}$$

$$[ Expression 26 ]$$

$${s}_{diff , c} := \vert s ( {Y}_{{P}_{L , c}}^{( 1 )} , {Y}_{{P}_{L , c}}^{( 1 )} ) - s ( {Y}_{{P}_{R , c}}^{( 1 )} , {Y}_{{P}_{R , c}}^{( 2 )} ) \vert \times \vert s ( {Y}_{{P}_{L , c}}^{( 1 ) ,} , {Y}_{{P}_{R , c}}^{( 1 ) ,} ) \vert ( {Y}_{{P}_{L , c}}^{( 1 ) ,} := {Y}_{{P}_{L , c}}^{( 1 )} ⋃ {Y}_{{P}_{L , c}}^{( 2 )} , the same applies to R )$$

The analysis unit 2 then selects an optimal division point c as indicated in Expression 27. In this manner, by determining the division point c of the explanatory variable x in such a way as to maximize the division evaluation index, the analysis unit 2 determines a branch rule in a model g having a decision tree structure by machine learning.

ĉ=argmax_{c∈C}s_{diff,c} [Expression 27]

In the machine learning of the decision tree described above, as a device for preventing overfitting, the analysis unit 2 may employ a device for preventing the tree from being too complicated, such as not performing the division in a case where pruning: max s_{diff,c} does not exceed a reference value, or may employ a device such as depth limitation or setting of a lower limit value of the number of leaf samples, similarly to a normal decision tree.

Next, processing by a second method by the data acquisition unit 1 and the analysis unit 2 of the information processing apparatus in the present example embodiment will be described. In the second method, the data acquisition unit 1 (acquisition unit) acquires, as data to be processed, sample data including a pair that can be the explanatory variable x and the target variable y in the prediction model h, similarly to the above (step S11 in FIG. 9). At this time, the data to be acquired is the data sets D of sample data to which an attribute is added in advance. In the present example embodiment, the attribute of the data set D is the time, and the data set D of the sample data with a time stamp is acquired as indicated in Expression 28. For example, it is assumed that the data set D is the sample data in which the learning data used at the time of the machine learning of the prediction model h described above and the operation data used at the time of the operation of the prediction model h subjected to the machine learning are mixed. A set of the explanatory variables is indicated in Expression 29.

$$[ Expression 28 ]$$

$$D := {\{ ( {t}_{i} , {x}_{i} , {y}_{i} ) \}}_{i = 1}^{N}$$

$$[ Expression 29 ]$$

$$X := \{ {x}_{i} \vert ( {x}_{i} , {y}_{i} ) ∈ {D}^{( 1 )} \}$$

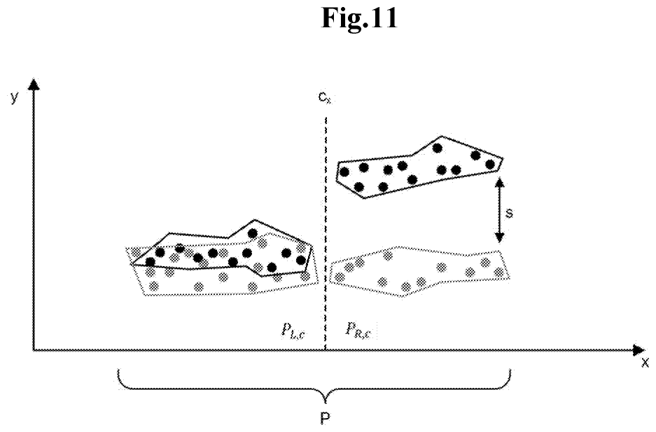

Here, FIG. 11 illustrates an example in which the data sets D are plotted in the coordinate space of the explanatory variable x and the target variable y. In the present example embodiment, the description will be given by exemplifying the time as the attribute added to the data sets, but the attribute added to the data sets D is not limited to the time. For example, the attribute added to the data sets D may be any attribute such as a place (region) where the sample data is acquired or an object from which the sample data is to be acquired.

The analysis unit 2 (learning unit) of the information processing apparatus in the present example embodiment then performs machine learning in such a way that a relationship between the explanatory variable x and a change in the target variable y is represented by a machine learning model having a decision tree structure based on the data sets D described above (step S12 in FIG. 9). Specifically, it is assumed that the analysis unit 2 performs machine learning for learning a rule for further dividing the data sets D by the time and the explanatory variable x as follows.

The analysis unit 2 arranges all the sample data of the data sets D in a root node as an initial state. The analysis unit 2 then recursively repeats the following processing starting from the root node. It is assumed that the root node P=X is the entire input space (feature space).

The analysis unit 2 sets a divided region (partition) of a parent node (current node) as in Expression 30, and extracts the data set D_{P} belonging to P as indicated in Expression 31.

P⊂χ [Expression 30]

D_{P}={(tᵢ,xᵢ,yᵢ)∈D|xᵢ∈P} [Expression 31]

Subsequently, the analysis unit 2 generates a division candidate set (data set candidate). Specifically, the analysis unit 2 searches for possible division points cₓ for each explanatory variable x based on the explanatory variable x of sample data in the data set Dₚ, and sets the division points cₓ as a division candidate set Cₓ. The analysis unit 2 also searches for possible division points for the time based on time stamps of the sample data in the data set Dₚ, and sets the division points as a division candidate set C_{T}. It is assumed that time division cₜ indicated in Expression 31 is a threshold of the time. As a result, the final division candidate set C is set as in Expression 33.

cₜ∈C_{T} [Expression 32]

C=C_{T}×C_{X}={(cₜ,cₓ)|cₜ∈C_{T},cₓ∈C_{X}} [Expression 33]

At this time, in division by the division candidate (cₜ, cₓ), as indicated in Expression 34, division into two types of a data set 1: Dₚ^{(1),ct} (learning data with old time) and a data set 2: Dₚ^{(2),ct} (operation data with new time) described above can be performed by the division by cₜ. As illustrated in FIG. 11, the parent node P is divided into left and right child nodes P_{L,cx} and P_{R,cx} by the division by cₓ. As a result, similarly to the first method described above, division into four sample sets is performed as indicated in Expression 35.

$$[ Expression 34 ]$$

$${D}_{P}^{( 1 ) , {c}_{t}} := \{ ( {t}_{i} , {x}_{i} , {y}_{i} ) ∈ {D}_{P} \vert {t}_{i} \leq {c}_{t} \}$$

$${D}_{P}^{( 2 ) , {c}_{t}} := \{ ( {t}_{i} , {x}_{i} , {y}_{i} ) ∈ {D}_{P} \vert {t}_{i} > {c}_{t} \}$$

$$[ Expression 35 ]$$

$${D}_{{P}_{L , {c}_{x}}}^{( 1 ) ,} := \{ ( {x}_{i} , {y}_{i} ) ∈ {D}_{P}^{( 1 ) , {c}_{t}} \vert {x}_{i} ∈ {P}_{L , {c}_{x}} \}$$

$${D}_{{P}_{R , {c}_{x}}}^{( 1 ) ,} := \{ ( {x}_{i} , {y}_{i} ) ∈ {D}_{P}^{( 1 ) , {c}_{t}} \vert {x}_{i} ∈ {P}_{R , {c}_{x}} \}$$

$${D}_{{P}_{L , {c}_{x}}}^{( 2 ) ,} := \{ ( {x}_{i} , {y}_{i} ) ∈ {D}_{P}^{( 2 ) , {c}_{t}} \vert {x}_{i} ∈ {P}_{L , {c}_{x}} \}$$

$${D}_{{P}_{R , {c}_{x}}}^{( 2 ) ,} := \{ ( {x}_{i} , {y}_{i} ) ∈ {D}_{P}^{( 2 ) , {c}_{t}} \vert {x}_{i} ∈ {P}_{R , {c}_{x}} \}$$

Subsequently, the analysis unit 2 calculates a division evaluation index in each division candidate. At this time, the division evaluation index may have any value as long as a difference between distribution change amounts of the target variables of the left and right child nodes can be evaluated. As an example, the division evaluation index is similar to that of the first method described above.

The analysis unit 2 then selects optimal division points cₜ hat and cₓ hat as indicated in Expression 36. As an example, the index is obtained by calculating s_{diff,c} in Expressions 24 to 26 above by using the four pieces of data in Expression 35. In this manner, by determining the division points cₜ hat and cₓ hat of a time t and the explanatory variable x in such a way as to maximize the division evaluation index, the analysis unit 2 determines a branch rule in the model g having the decision tree structure by machine learning. Also in the second method, a device for preventing the number of samples from being biased or a device for preventing overfitting may be performed similarly to the above.

(ĉₜ,ĉₓ)=argmax_{(c}_{ₜ}_{,c}_{ₓ}_{)∈C}s_{diff,c}_{ₜ}_{,c}_{ₓ} [Expression 36]

In the above description, a change amount s of p(y|x) set as the division evaluation index may be a pattern including a direction of a temporal change that is the attribute of each sample data, similarly to the above. In this case, it is assumed that a pattern s is a certain amount that can be defined using the target variable y and information regarding the time stamp (time) t. As an example of the pattern s, as information representing a change in the target variable y with respect to a change in the time, a speed of the change in the target variable y may be quantified as a change s, as indicated in the following Expression 37. It is assumed that t₁ and t₂ are times (average times of the time stamps) at which the data set 1: Dₚ^{(1),ct} and the data set 2: Dₚ^{(2),ct} are collected. Y_{PL,cx}^{(1),ct} is a target variable portion of D_{PL,cx}^{(1),ct}, and the same applies to the others.

$$[ Expression 37 ]$$

$${s}_{diff , {c}_{t} , {c}_{x}} := \frac{\vert s ( {Y}_{{P}_{L , {c}_{x}}}^{( 1 ) , {c}_{t}} , {Y}_{{P}_{L , {c}_{x}}}^{( 2 ) ,} ) - s ( {Y}_{{P}_{R , {c}_{x}}}^{( 1 ) ,} , {Y}_{{P}_{R , {c}_{x}}}^{( 2 ) ,} ) \vert}{{t}_{2} - {t}_{1}}$$

Next, processing by a third method by the data acquisition unit 1 and the analysis unit 2 of the information processing apparatus in the present example embodiment will be described. In the third method, the data acquisition unit 1 (acquisition unit) acquires, as data to be processed, sample data including a pair that can be the explanatory variable x and the target variable y in the prediction model h, similarly to the above (step S11 in FIG. 9). At this time, similarly to the above, the data to be acquired is the data sets D of sample data to which a time stamp (time) is added in advance as an attribute. In the present example embodiment, the description will be given by exemplifying the time as the attribute added to the data sets, but the attribute added to the data sets D is not limited to the time. For example, the attribute added to the data sets D may be any attribute such as a place (region) where the sample data is acquired or an object from which the sample data is to be acquired.

The analysis unit 2 (learning unit) of the information processing apparatus in the present example embodiment then performs machine learning in such a way that a relationship between the explanatory variable x and a change in the target variable y is represented by a machine learning model having a decision tree structure based on the data sets D described above (step S12 in FIG. 9). Specifically, it is assumed that the analysis unit 2 performs machine learning for learning a rule for dividing the data sets D by the explanatory variable x in consideration of the time t as follows.

The analysis unit 2 arranges all the sample data of the data sets D in a root node as an initial state. The analysis unit 2 then recursively repeats the following processing starting from the root node. It is assumed that a root node P=X is the entire input space (feature space).

The analysis unit 2 sets a divided region (partition) of a parent node (current node) as in Expression 38, and extracts a data set D_{P} belonging to P as indicated in Expression 39.

P⊂λ [Expression 38]

D_{P}:={(tᵢ,xᵢ,yᵢ)∈D|xᵢ∈P} [Expression 39]

Subsequently, the analysis unit 2 generates a division candidate set (data set candidate). Specifically, the analysis unit 2 searches for possible division points for each explanatory variable x based on the explanatory variable x of sample data in the data set Dₚ, and sets the division points as a division candidate set C. Then, the parent node P is divided into the left and right child nodes P_{L,c} and P_{R,c} by the division by the division candidate c. As a result, division into two left and right sample sets is performed as indicated in Expression 40.

D_{P}_{_{L,c}}:={(tᵢ,xᵢ,yᵢ)∈D_{P}|xᵢ∈P_{L,c}}

D_{P}_{_{R,c}}:={(tᵢ,xᵢ,yᵢ)∈D_{P}|xᵢ∈P_{R,c}} [Expression 40]

Subsequently, the analysis unit 2 calculates a division evaluation index in each division candidate. At this time, the division evaluation index may have any value as long as a difference between distribution change amounts of the target variables of the left and right child nodes can be evaluated. However, in this example, since division by the time t is not performed, it is assumed that left and right division is evaluated while utilizing t. That is, it is assumed that the time stamp is used as the division evaluation index. For example, the division evaluation index indicated in Expression 41 is used.

s_{diff,c}=|s(D_{P}_{_{L,c}})−s(D_{P}_{_{R,c}})| [Expression 41]

At this time, s in Expression 41 is a function (information regarding the time is essential) that receives data and quantifies a change amount in Y in the data, and is indicated in Expression 42 as an example. As s, a method such as a change point detection method or a test on whether a series is stationary (unit root test (ADF test or the like)) can be utilized. In Expression 42, i and j are sample indices obtained by sorting, by the time stamp, target data indicated in Expression 43 for calculating s, and are set as in, for example, Expression 44.

$$[ Expression 42 ]$$

$$s = ( maximum value of moving average of Y ) - ( minimum value of moving average of Y ) = {max}_{i} \frac{1}{K} {\sum }_{j = i}^{i + K} {y}_{j} - {min}_{i} \frac{1}{K} {\sum }_{j = i}^{i + K} {y}_{j}$$

$$[ Expression 43 ]$$

$${D}_{{P}_{L , c}} , {D}_{{P}_{R , c}}$$

$$[ Expression 44 ]$$

$$i ∈ \{ 1 , … , \vert {D}_{{P}_{L , c}} \vert \}$$

The analysis unit 2 then selects the optimal division point ĉ as indicated in Expression 45. In this manner, by determining the division point ĉ of the explanatory variable x in such a way as to maximize the division evaluation index, the analysis unit 2 determines a branch rule in the model g having the decision tree structure by machine learning.

ĉ=argmax_{c∈C}s_{diff,c} [Expression 45]

In the above description, the case has been exemplified where the analysis unit 2 performs the machine learning in such a way that the relationship between the explanatory variable x and the change in the target variable y is represented from the data sets D by the machine learning model having the decision tree structure, but the analysis unit 2 may perform the machine learning in such a way that such a relationship is represented by a machine learning model having an interpretable structure, such as a machine learning model having a rule-based structure.

The visualization unit 3 (output unit) in the present example embodiment then visualizes at least a part of the model subjected to the machine learning as described above (step S13 in FIG. 9). Specifically, the visualization unit 3 outputs the rules of the machine learning model having the decision tree structure and subjected to the machine learning, the corresponding sample data, and the like to be displayed on a monitor browsable by a user, similarly to the first example embodiment described above. As an example, as illustrated in FIG. 7(7-1), the visualization unit 3 displays a rule table indicating a list of branch rules corresponding to nodes in the decision tree, and outputs, together with each rule, information based on the rule such as a prediction value, that is, the change amount s by the model g in the related rule, the number and a ratio of sample data satisfying the related rule, and the like to be displayed. As an example, as illustrated in FIG. 7(7-2), the visualization unit 3 displays a tree diagram of the decision tree including the nodes and edges, and displays the branch rule corresponding to each node, the prediction value in the related branch rule, the number and ratio of sample data satisfying the related branch rule, and the like. At this time, in a case where a predetermined node is selected by the user in the tree diagram, information related to the branch rule corresponding to such a node may be displayed. At this time, a color of the node to be displayed may be displayed in a color related to the corresponding prediction value.

As an example, as illustrated in FIG. 7(7-3), the visualization unit 3 may visualize and output the model g with Treemap that is a format in which hierarchical data is expressed in rectangular regions. For example, the visualization unit 3 may display the branch rule in each segment (region) in Treemap, and display the corresponding branch rule, the prediction value, the number and ratio of sample data, and the like in each segment. At this time, a size of the segment may be adjusted and displayed according to the number and ratio of sample data satisfying the corresponding branch rule, and/or a color of the segment may be displayed in a color related to the corresponding prediction value.

As an example, the visualization unit 3 may reduce a dimension of each sample data of the data set 1 and the data set 2 (for example, to two or three dimensions), and output a scatter diagram of the dimensionally reduced sample data to be displayed as illustrated in FIG. 7(7-4). In the example of FIG. 7(7-4), the dimension of the sample data is reduced to two dimensions, and each sample data is displayed by each marker such as a circle, a square, or a triangle. At this time, a shape of the marker is distinguished for each branch rule (segment), and a color of the marker is set according to the change amount. In a case where a predetermined marker is selected by the user, the visualization unit 3 may display information related to the branch rule corresponding to such a marker. In a case where the predetermined sample data is selected by the user, the visualization unit 3 may further display markers related to sample data of the same segment as the selected sample data by connecting or enclosing the markers with a line.

As an example, the visualization unit 3 plots and displays information related to the target variable corresponding to the rule displayed as described above on a predetermined coordinate space (step S14 in FIG. 9). For example, as illustrated in FIG. 8, in a case where a predetermined segment is selected by the user in Treemap, the visualization unit 3 outputs the target variable y of sample data corresponding to a rule of the selected segment to be plotted and displayed on a coordinate space of the time and the target variable. In this manner, by plotting the target variable y satisfying the predetermined rule in time series, a trend of the change can be visualized. At this time, the plot may be displayed together with a smoothed curve such as a moving average of the target variable y. Also in a case where a predetermined node portion is selected in the tree diagram described above, the visualization unit 3 may display a time-series change of the target variable y corresponding to a rule of the selected node as illustrated in FIG. 8.

The case of predicting the number of patients in a predetermined hospital described in the above first example embodiment can also be applied to the information processing apparatus in the present example embodiment. As a result, even in a case where performance of a patient number prediction model in operation in the hospital deteriorates, it is possible to easily recognize a cause of the deterioration by performing machine learning in such a way that a change in a target variable is represented by an interpretable model by using the information processing apparatus of the present disclosure. As a result, it is possible to take appropriate measures such as relearning of the patient number prediction model, and it is possible to support decision making by a doctor by improving prediction accuracy of the patient number prediction model.

As described above, in the present disclosure, the rule in the model can be easily interpreted by performing the machine learning in such a way that the relationship between the explanatory variable and the change in the target variable of the data set is represented by the interpretable model such as the decision tree. As a result, it is possible to easily interpret when and where the change in the target variable, that is, a concept drift has occurred and how the concept has changed, and to appropriately cope with the performance deterioration of the prediction model.

### Third Example Embodiment

Next, a third example embodiment of the present disclosure will be described with reference to the drawings. In the present example embodiment, an outline of the information processing apparatuses and the like described in the above-described example embodiments will be illustrated. The drawings may relate to any example embodiment.

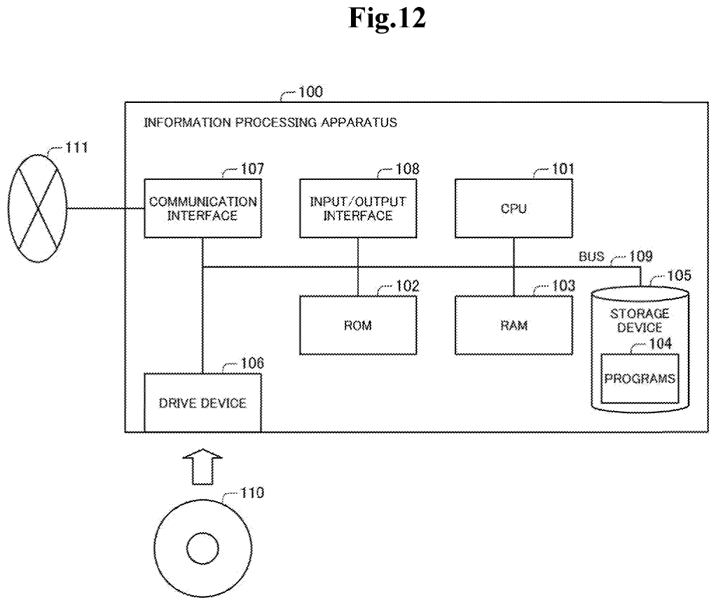

First, a hardware configuration of an information processing apparatus 100 in the present disclosure will be described. The information processing apparatus 100 is constituted by a general information processing apparatus, and is equipped with, as an example, the hardware configuration as follows, as illustrated in FIG. 12.
A central processing unit (CPU) 101 (arithmetic device)
A read only memory (ROM) 102 (storage device)
A random access memory (RAM) 103 (storage device)
Programs 104 to be loaded into the RAM 103
A storage device 105 that stores the programs 104
A drive device 106 that performs reading and writing on a storage medium 110 outside the information processing apparatus
A communication interface 107 connected to a communication network 111 outside the information processing apparatus
An input/output interface 108 that inputs and outputs data
A bus 109 that connects each component

FIG. 12 illustrates an example of the hardware configuration of the information processing apparatus that is the information processing apparatus 100, and the hardware configuration of the information processing apparatus is not limited to the case described above. For example, the information processing apparatus may be constituted by a part of the above-described configuration such as not including the drive device 106. The information processing apparatus can use, instead of the above-described CPU, a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

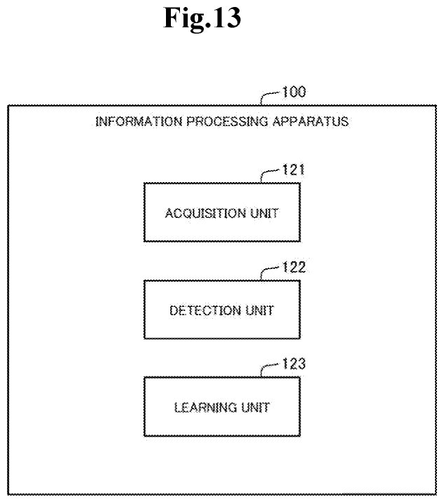

An acquisition unit 121, a detection unit 122, and a learning unit 123 illustrated in FIG. 13 can be constructed and equipped in the information processing apparatus 100 by the CPU 101 acquiring and executing the programs 104. The programs 104 are stored in, for example, the storage device 105 or the ROM 102 in advance, and the CPU 101 loads and executes the programs 104 on the RAM 103, as necessary. The programs 104 may be supplied to the CPU 101 via the communication network 111, or the programs 104 may be stored in the storage medium 110 in advance and the drive device 106 may read the programs 104 and supply the read programs 104 to the CPU 101. However, the acquisition unit 121, the detection unit 122, and the learning unit 123 described above may be constructed with a dedicated electronic circuit for achieving such means.

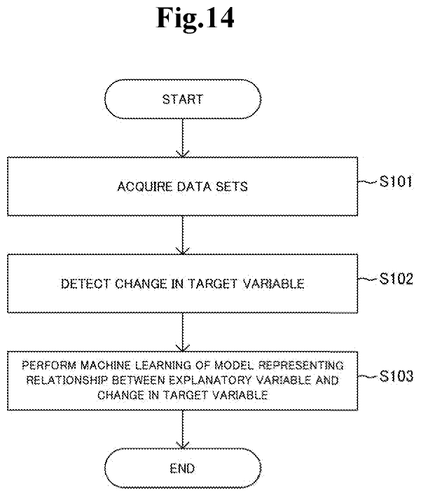

The above acquisition unit 121 acquires equal to or more than two data sets including data including a pair of an explanatory variable and a target variable (step S101 in FIG. 14). The above detection unit 122 detects change information based on a change in the target variable related to the explanatory variable between the data sets (step S102 in FIG. 14). The above learning unit 123 performs machine learning in such a way that a relationship between the explanatory variable and the change information is represented by a machine learning model having an interpretable structure (step S103 in FIG. 14).

In the above configuration, the information processing apparatus 100 performs machine learning in such a way that the relationship between the explanatory variable and the change in the target variable of the data set is represented by the interpretable machine learning model such as a model having a decision tree structure or a model having a rule-based structure. As a result, a rule in the model can be easily interpreted, and an appropriate measure against a concept drift can be taken.

At least one or more of the functions of the acquisition unit 121, the detection unit 122, and the learning unit 123 described above may be executed by an information processing apparatus installed and connected at any place on the network, that is, may be executed by so-called cloud computing.

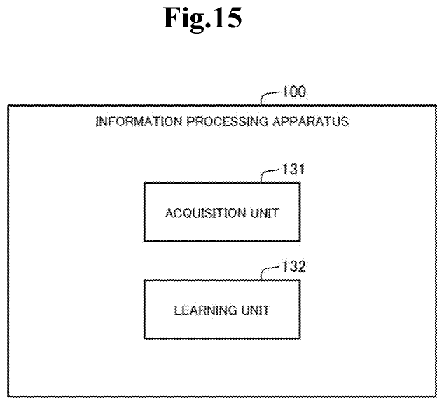

As another configuration, an acquisition unit 131 and a learning unit 132 illustrated in FIG. 15 can be constructed and equipped in the information processing apparatus 100 by the CPU 101 acquiring and executing the programs 104. The programs 104 are stored in, for example, the storage device 105 or the ROM 102 in advance, and the CPU 101 loads and executes the programs 104 on the RAM 103, as necessary. The programs 104 may be supplied to the CPU 101 via the communication network 111, or the programs 104 may be stored in the storage medium 110 in advance and the drive device 106 may read the programs 104 and supply the read programs 104 to the CPU 101. However, the acquisition unit 131 and the learning unit 132 described above may be constructed with a dedicated electronic circuit for achieving such means.

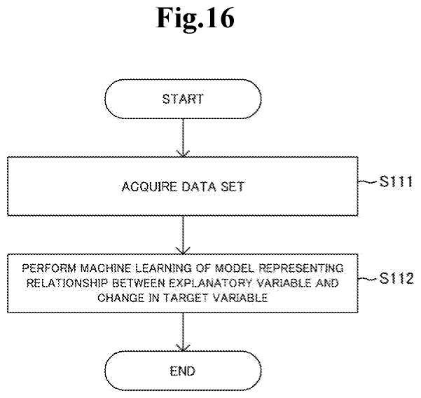

The above acquisition unit 131 acquires a data set including data including a pair of an explanatory variable and a target variable and having a predetermined attribute (step S111 in FIG. 16). The above learning unit 132 divides the data set into a plurality of data set candidates based on the attribute and the explanatory variable, and performs machine learning in such a way that a relationship between the explanatory variable and change information based on a change in the target variable related to the explanatory variable between the data set candidates is represented by a machine learning model having a decision tree structure (step S112 in FIG. 16).

In the above configuration, the information processing apparatus 100 performs the machine learning in such a way that the relationship between the explanatory variable and the change in the target variable of the data set is represented by an interpretable machine learning model such as the model having the decision tree structure based on the attribute of the data set and the explanatory variable. As a result, a rule in the model can be easily interpreted, and an appropriate measure against the concept drift can be taken.

At least one or more of the functions of the acquisition unit 131 and the learning unit 132 described above may be executed by an information processing apparatus installed and connected at any place on the network, that is, may be executed by so-called cloud computing.

The above-described programs can be stored using various types of non-transitory computer readable media and supplied to a computer. The non-transitory computer readable media include various types of tangible storage media. Examples of the non-transitory computer readable medium include a magnetic recording medium (for example, flexible disk, magnetic tape, or hard disk drive), an optical magnetic recording medium (for example, magneto-optical disc), a compact disc-read only memory (CD-ROM), a CD-R, a CD-R/W, and a semiconductor memory (for example, mask ROM, programmable ROM (PROM), erasable PROM (EPROM), a flash ROM, or a random access memory (RAM)). The programs may also be supplied to the computer by various types of transitory computer readable media. Examples of the transitory computer readable media include electrical signals, optical signals, and electromagnetic waves. The transitory computer readable media can supply the programs to the computer via a wired communication path such as an electric wire and an optical fiber or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

### <Supplementary Notes>

Some or all of the above example embodiments may also be described as in the following Supplementary Notes. Hereinafter, an outline of the configurations of the information processing apparatus, the information processing method, and the program in the present disclosure will be described. However, the present disclosure is not limited to the configurations described in the following Supplementary Notes.

Some or all of the configurations described in Supplementary Notes A2 to A8.3 dependent on Supplementary Note A1 described below and the functions according to those configurations can also be dependent on the other Supplementary Notes A9 and A10 by a dependency relationship similar to that of Supplementary Notes A2 to A8.3. Some or all of the configurations described as Supplementary Notes and the functions according to those configurations can be similarly dependent on not only Supplementary Notes A1, A9, and A10, but also similar hardware and software, and various types of recording means that record the software, or systems without departing from the above-described example embodiments.

Some or all of the configurations described in Supplementary Notes B2 to B8 dependent on Supplementary Note B1 described below and the functions according to those configurations can also be dependent on the other Supplementary Notes B9 and B10 by a dependency relationship similar to that of Supplementary Notes B2 to B8. Some or all of the configurations described as Supplementary Notes and the functions according to those configurations can be similarly dependent on not only Supplementary Notes B1, B9, and B10, but also similar hardware and software, and various types of recording means that record the software, or systems without departing from the above-described example embodiments.

Some or all of the configurations described in Supplementary Notes A1 to A10.1 described below and the functions according to those configurations can also be incorporated into the other Supplementary Notes B1 to B10.1. Similarly, some or all of the configurations described in Supplementary Notes B1 to B10.1 described below and the functions according to those configurations can also be incorporated into the other Supplementary Notes A1 to A10.1.

### (Supplementary Note A1)

An information processing apparatus including:
an acquisition unit that acquires equal to or more than two data sets including data including a pair of an explanatory variable and a target variable;
a detection unit that detects change information based on a change in the target variable related to the explanatory variable between the data sets; and
a learning unit that performs machine learning in such a way that a relationship between the explanatory variable and the change information is represented by a machine learning model having an interpretable structure.

### (Supplementary Note A2)

The information processing apparatus according to Supplementary Note A1, further including
an output unit that outputs information based on at least a part of rules for predicting the change information from the explanatory variable in the machine learning model subjected to the machine learning.

### (Supplementary Note A3)

The information processing apparatus according to Supplementary Note A2, in which
the output unit outputs the target variable corresponding to a predetermined rule.

### (Supplementary Note A4)

The information processing apparatus according to Supplementary Note A1, in which
the detection unit detects, as the change information, a change amount of the target variable related to the explanatory variable located in a predetermined neighboring region between the data sets.

### (Supplementary Note A5)

The information processing apparatus according to Supplementary Note A1, in which
the detection unit generates a model representing the relationship between the explanatory variable and the target variable in each of the data sets, and detects, as the change information, a change amount of the target variable related to the explanatory variable between the models of the data sets.

### (Supplementary Note A6)

The information processing apparatus according to Supplementary Note A1, in which
the detection unit detects, as the change information, information based on a change in an attribute and a change in the target variable related to the explanatory variable between the data sets having different attributes associated with the data.

### (Supplementary Note A7)

The information processing apparatus according to Supplementary Note A1, in which
the learning unit performs machine learning in such a way that the relationship between the explanatory variable and the change information is represented by the machine learning model having a decision tree structure or a rule-based structure.

### (Supplementary Note A8)

The information processing apparatus according to Supplementary Note A2, in which
the output unit outputs information based on a branch rule in the machine learning model having a decision tree structure.

### (Supplementary Note A8.1)

The information processing apparatus according to Supplementary Note A2, in which
the output unit outputs information based on a rule in the machine learning model having a rule-based structure.

### (Supplementary Note A8.2)

The information processing apparatus according to Supplementary Note A3, in which
the output unit outputs information based on the target variable corresponding to the selected rule among the output rules.

### (Supplementary Note A8.3)

The information processing apparatus according to Supplementary Note A3, in which
the output unit plots and outputs information related to the target variable corresponding to a predetermined rule in a predetermined space.

### (Supplementary Note A9)

An information processing method by an information processing apparatus,
the information processing method including:
acquiring equal to or more than two data sets including data including a pair of an explanatory variable and a target variable;
detecting change information based on a change in the target variable related to the explanatory variable between the data sets; and
performing machine learning in such a way that a relationship between the explanatory variable and the change information is represented by a machine learning model having an interpretable structure.

### (Supplementary Note A9.1)

The information processing method according to Supplementary Note A9, in which
the information processing apparatus
outputs information based on at least a part of rules for predicting the change information from the explanatory variable in the machine learning model subjected to the machine learning.

### (Supplementary Note A10)

A program for causing an information processing apparatus to execute processing of:
acquiring equal to or more than two data sets including data including a pair of an explanatory variable and a target variable;
detecting change information based on a change in the target variable related to the explanatory variable between the data sets; and
performing machine learning in such a way that a relationship between the explanatory variable and the change information is represented by a machine learning model having an interpretable structure.

### (Supplementary Note A10.1)

The program according to Supplementary Note A10, for further causing the information processing apparatus to execute processing of
outputting information based on at least a part of rules for predicting the change information from the explanatory variable in the machine learning model subjected to the machine learning.

### (Supplementary Note B1)

An information processing apparatus including:
an acquisition unit that acquires a data set including data including a pair of an explanatory variable and a target variable and having a predetermined attribute; and
a learning unit that divides the data set into a plurality of data set candidates based on the attribute and the explanatory variable, and performs machine learning in such a way that a relationship between the explanatory variable and change information based on a change in the target variable related to the explanatory variable between the data set candidates is represented by a machine learning model having a decision tree structure.

### (Supplementary Note B2)

The information processing apparatus according to Supplementary Note B1, further including
an output unit that outputs information based on at least a part of branch rules of the decision tree structure that is the machine learning model subjected to the machine learning.

### (Supplementary Note B3)

The information processing apparatus according to Supplementary Note B2, in which
the output unit outputs the target variable corresponding to a predetermined branch rule.

### (Supplementary Note B4)

The information processing apparatus according to Supplementary Note B1, in which
the acquisition unit acquires at least two of the data sets distinguished by the attribute, and
the learning unit divides each of the data sets distinguished by the attribute into the data set candidates based on the explanatory variable, and performs machine learning in such a way that the relationship between the explanatory variable and the change information based on the change in the target variable related to the explanatory variable between the data set candidates is represented by the machine learning model having the decision tree structure.

### (Supplementary Note B5)

The information processing apparatus according to Supplementary Note B1, in which
the acquisition unit acquires the data set including the data to which the attribute is added, and
the learning unit divides the data set into the data set candidates based on each of the attribute and the explanatory variable, and performs machine learning in such a way that the relationship between the explanatory variable and the change information based on the change in the target variable related to the explanatory variable between the data set candidates is represented by the machine learning model having the decision tree structure.

### (Supplementary Note B6)

The information processing apparatus according to Supplementary Note B1, in which
the acquisition unit acquires the data set including the data to which the attribute is added, and
the learning unit divides the data set into the data set candidates based on the explanatory variable, and performs machine learning in such a way that the relationship between the explanatory variable and the change information based on the change according to the attribute in the target variable related to the explanatory variable between the data set candidates is represented by the machine learning model having the decision tree structure.

### (Supplementary Note B7)

The information processing apparatus according to Supplementary Note B3, in which
the output unit outputs information based on the target variable corresponding to the selected branch rule among the output branch rules.

### (Supplementary Note B8)

The information processing apparatus according to Supplementary Note B3, in which
the output unit plots and outputs information related to the target variable corresponding to the predetermined branch rule in a predetermined space.

### (Supplementary Note B9)

An information processing method by an information processing apparatus, the information processing method including:
acquiring a data set including data including a pair of an explanatory variable and a target variable and having a predetermined attribute; and
dividing the data set into a plurality of data set candidates based on the attribute and the explanatory variable, and performing machine learning in such a way that a relationship between the explanatory variable and change information based on a change in the target variable related to the explanatory variable between the data set candidates is represented by a machine learning model having a decision tree structure.

### (Supplementary Note B9.1)

The information processing method according to Supplementary Note B9, in which
the information processing apparatus
further outputs information based on at least a part of branch rules of the decision tree structure that is the machine learning model subjected to the machine learning.

### (Supplementary Note B10)

A program for causing an information processing apparatus to execute processing of:
acquiring a data set including data including a pair of an explanatory variable and a target variable and having a predetermined attribute; and
dividing the data set into a plurality of data set candidates based on the attribute and the explanatory variable, and performing machine learning in such a way that a relationship between the explanatory variable and change information based on a change in the target variable related to the explanatory variable between the data set candidates is represented by a machine learning model having a decision tree structure.

### (Supplementary Note B10.1)

The program according to Supplementary Note B10, for further causing the information processing apparatus to execute processing of
outputting information based on at least a part of branch rules of the decision tree structure that is the machine learning model subjected to the machine learning.

1. An information processing apparatus comprising:
at least one memory configured to store processing instructions; and
at least one processor configured to execute the processing instructions to:
acquire equal to or more than two data sets including data including a pair of an explanatory variable and a target variable;
detect change information based on a change in the target variable related to the explanatory variable between the data sets; and
perform machine learning in such a way that a relationship between the explanatory variable and the change information is represented by a machine learning model having an interpretable structure.

2. The information processing apparatus according to claim 1, wherein the at least one processor is configured to execute the processing instructions to
output information based on at least a part of rules for predicting the change information from the explanatory variable in the machine learning model subjected to the machine learning.

3. The information processing apparatus according to claim 2, wherein the at least one processor is configured to execute the processing instructions to
output the target variable corresponding to a predetermined rule.

4. The information processing apparatus according to claim 1, wherein the at least one processor is configured to execute the processing instructions to
detect, as the change information, a change amount of the target variable related to the explanatory variable located in a predetermined neighboring region between the data sets.

5. The information processing apparatus according to claim 1, wherein the at least one processor is configured to execute the processing instructions to
generate a model representing the relationship between the explanatory variable and the target variable in each of the data sets, and detect, as the change information, a change amount of the target variable related to the explanatory variable between the models of the data sets.

6. The information processing apparatus according to claim 1, wherein the at least one processor is configured to execute the processing instructions to
detect, as the change information, information based on a change in an attribute and a change in the target variable related to the explanatory variable between the data sets having different attributes associated with the data.

7. The information processing apparatus according to claim 1, wherein the at least one processor is configured to execute the processing instructions to
perform machine learning in such a way that the relationship between the explanatory variable and the change information is represented by the machine learning model having a decision tree structure or a rule-based structure.

8. The information processing apparatus according to claim 2, wherein the at least one processor is configured to execute the processing instructions to
output information based on a branch rule in the machine learning model having a decision tree structure.

9. An information processing method by an information processing apparatus, the information processing method comprising:
acquiring equal to or more than two data sets including data including a pair of an explanatory variable and a target variable;
detecting change information based on a change in the target variable related to the explanatory variable between the data sets; and
performing machine learning in such a way that a relationship between the explanatory variable and the change information is represented by a machine learning model having an interpretable structure.

10. The information processing method according to claim 9, wherein
the information processing apparatus
outputs information based on at least a part of rules for predicting the change information from the explanatory variable in the machine learning model subjected to the machine learning.

11. The information processing method according to claim 10, wherein
the information processing apparatus
outputs the target variable corresponding to a predetermined rule.

12. The information processing method according to claim 9, wherein
the information processing apparatus
detects, as the change information, a change amount of the target variable related to the explanatory variable located in a predetermined neighboring region between the data sets.

13. The information processing method according to claim 9, wherein
the information processing apparatus
generates a model representing the relationship between the explanatory variable and the target variable in each of the data sets, and detects, as the change information, a change amount of the target variable related to the explanatory variable between the models of the data sets.

14. The information processing method according to claim 9, wherein
the information processing apparatus
detects, as the change information, information based on a change in an attribute and a change in the target variable related to the explanatory variable between the data sets having different attributes associated with the data.

15. The information processing method according to claim 9, wherein
the information processing apparatus
performs machine learning in such a way that the relationship between the explanatory variable and the change information is represented by the machine learning model having a decision tree structure or a rule-based structure.

16. The information processing method according to claim 10, wherein
the information processing apparatus
outputs information based on a branch rule in the machine learning model having a decision tree structure.

17. A non-transitory computer readable storage medium storing a program for causing an information processing apparatus to execute processing of:
acquiring equal to or more than two data sets including data including a pair of an explanatory variable and a target variable;
detecting change information based on a change in the target variable related to the explanatory variable between the data sets; and
performing machine learning in such a way that a relationship between the explanatory variable and the change information is represented by a machine learning model having an interpretable structure.
